(19) United States
(12) Patent Application Publication
(10) Pub. No.: US 2018/0359997 A1
(43) Pub. Date: Dec. 20, 2018

(54) Dog Loop Leash

(71) Applicant: Richard N. Hogg, Fayetteville, NC (US)

(72) Inventor: Richard N. Hogg, Fayetteville, NC (US)

(21) Appl. No.: 16/009,788

(22) Filed: Jun. 15, 2018

Related U.S. Application Data
(60) Provisional application No. 62/519,893, filed on Jun. 15, 2017.

(51) Int. Cl. A01K 27/00

(52) U.S. Cl. CPC A01K 27/003; A01K 27/005

(57) ABSTRACT

A device and method for the handling of a canine by means of a loop leash employed attached to a handler's body in a hands free arrangement or for positive manual manipulation of the distance of the canine from the handler. The device is comprised an elongate segment of flexible material with two ends, a handle loop on one end and canine collar attaching loops at the other end of the elongate segment of flexible material and a plurality of loops located between the handle loop and canine collar attaching loops of the segment of flexible material for additional handling functionality.

### PRIORITY

This application claims priority to U.S. Provisional Application No. 62/519,893 filed Jun. 15, 2017.

### BACKGROUND OF INVENTION

It is the objective of the present invention to provide an apparatus and the methods of using that apparatus for the application of a dog loop leash. More particularly, the present invention includes an elongate segment of flexible materials with a handle loop on one end and canine attaching collar loops on the other end with a plurality of loops located between the handle loop and canine collar attaching loops for additional handling functionality.

Currently there is no adjustable length, grip position canine leash available for a canine handler or owner that allows the handler to manually control the distance of the canine from the handler. The instant invention offers the canine handler the ability to adjust the length of the leash with minimal grip strength. In one preferred embodiment, the approximately seven foot long leash has a series of loops at one foot intervals to provide the canine handler flexibility and control to adjust the length of the working end of the leash. This is done by the handler simply moving his or her hands from loop to loop to either extend or retract the length of the canine from the handler. The present invention does not require a closed hand grip to maintain control of the leash, a simple “hooked hand” is all that is needed to control the canine on the leash, thus reducing forearm muscle fatigue. Further, a preferred embodiment of the present invention is constructed of nylon for strength and lightness.

Additionally, a handler my use the leash of the present invention to secure the canine to his or her person my wrapping the leash around the handler's waist and securing it by pulling the working end of the lease through one of the plurality of loops located between the handle loop and canine collar attaching loops and then securing the canine to the canine collar attaching loops. In this configuration, a handler can operate the leash with a canine attached hands free. Of course, this is necessary when the handler is holding a firearm while moving through a space—such as attempting the clear a hostile environment.

The present invention differs from the prior art in that the prior art does not teach the preferred embodiment of the present invention of an all material leash (in one preferred embodiment nylon or other light weight material with good strength) with the handle loop, the canine attaching collar loops and the plurality of loops located between the handle loop and canine collar attaching loops all configured to collapse onto themselves when the leash is under tension. Further, the prior art does not teach methods of using the dog loop leash attached to the user in hands free operation or, alternatively, controlling the distance of the canine from the handler by hand-over-hand manipulation of the of the plurality of loops located between the handle loop and canine collar attaching loops.

### BRIEF SUMMARY OF INVENTION

The present invention discloses a loop leash for operation of canine. The invention includes a leash made from flexible, light weight strong materials with a handle loop on one end and canine collar attaching loops on the other end. In between these end points, a series of loops are located to provide additional handling functionality. All of the loops on the leash collapse onto themselves when the leash is under tension (from the attached canine pulling on the leash) in order that no snagging of the leash on surrounding environment can occur when in use.

The present invention discloses methods of operation of the loop leash. Specifically, securing the loop leash around the handler's waist and then securing to the canine to allow hands free operation. Additionally, securing the loop leash to the canine at the canine collar attaching loops and then adjusting the distance between the handler and the canine by positive manual manipulation of the series of loops located between the handle loop and the canine attaching loops.

### DRAWINGS

FIG. 1 is a top view of the dog control device of a preferred embodiment of the present invention.

FIG. 2 is a side view of the dog control device of a preferred embodiment of the present invention.

FIG. 2A is an exploded view of a portion of FIG. 2 of the dog control device of a preferred embodiment of the present invention.

FIG. 2B is an exploded view of a portion of FIG. 2 of the dog control device of a preferred embodiment of the present invention.

FIG. 3 is an isometric view of the dog control device in use of a preferred embodiment of the present invention.

FIG. 4 is an isometric view of the dog control device in use of a preferred embodiment of the present invention.

FIG. 5 is an isometric view of the dog control device in use of a preferred embodiment of the present invention.

FIG. 6 is an isometric view of the dog control device in use of a preferred embodiment of the present invention.

FIG. 7 is an exploded view of the canine collar attaching end of the dog control device in use of a preferred embodiment of the present invention.

FIG. 8 is a view showing the canine collar attaching end of the dog control device in use of a preferred embodiment of the present invention folded.

### DETAILED DESCRIPTION OF INVENTION

The present invention will now be described in terms of the presently preferred embodiment thereof as illustrated in the drawings. Those of ordinary skill in the art will recognize that many obvious modifications may be made thereto without departing from the spirit or scope of the present invention.

The present invention is directed to address the short comings in prior dog control devices (leashes) by implementing control loops in between the handle portion and the canine attaching collar portion of the dog control device.

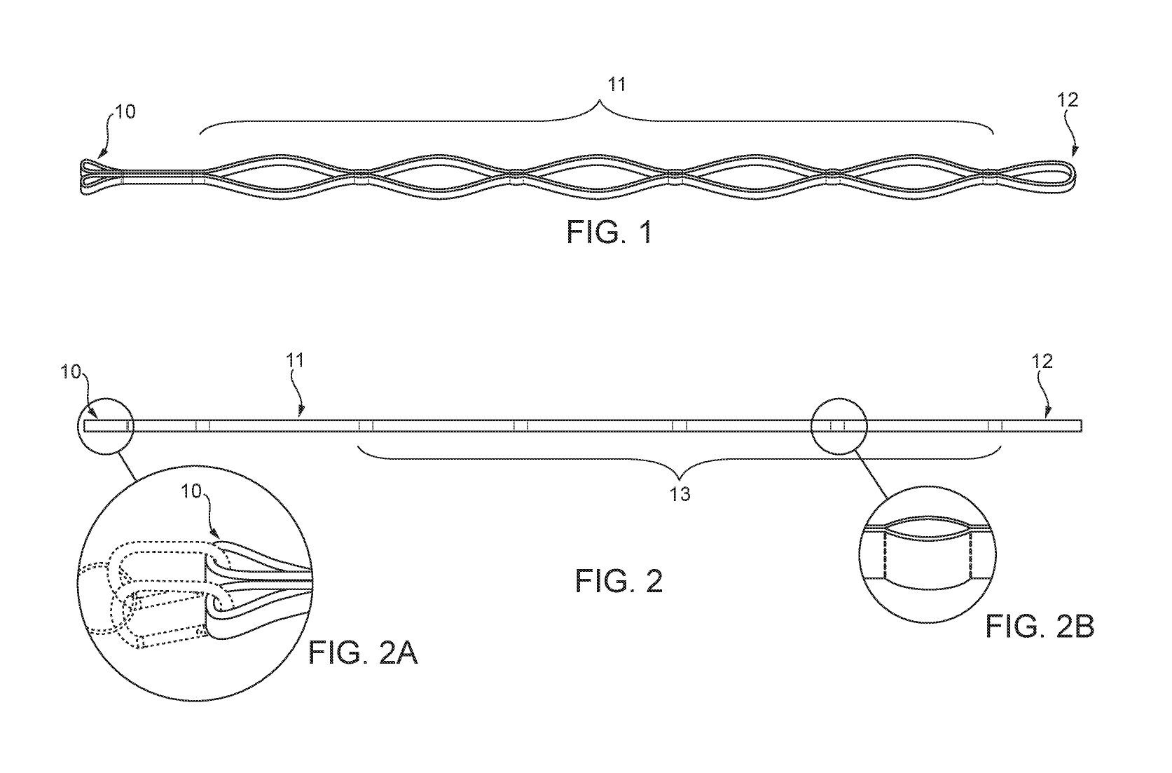

FIG. 1 shows the leash extended without tension applied. The control loops (11), handle loop (12) and canine attaching collar loops (10) are expanded. The connection points between the loops are stitched using a bar tack stitch or similar attaching technique for areas experiencing high tensile loads. See, FIG. 2 and FIG. 2B. In one preferred embodiment, the leash is made from nylon or similar light-weight strong materials.

FIG. 2 shows the leash extended (13) with tension applied like it would be with a canine attached to the leash at (10). Here, the control lops (11) are collapsed and flush so as to avoid snagging when in operation. The canine collar attaching loops (10) can be used with redundant carbineer attachments (FIG. 2A) or hook and claps attachments (FIG. 7). The dual carbineer's provides a more positive and secure method of attaching to the canine collar. In a preferred embodiment, there are two parallel bar tack stitched connection points between the loops offering a small loop for use of a control device (i.e., a carabineer) for additional functionality and adaptability. See, FIG. 2B.

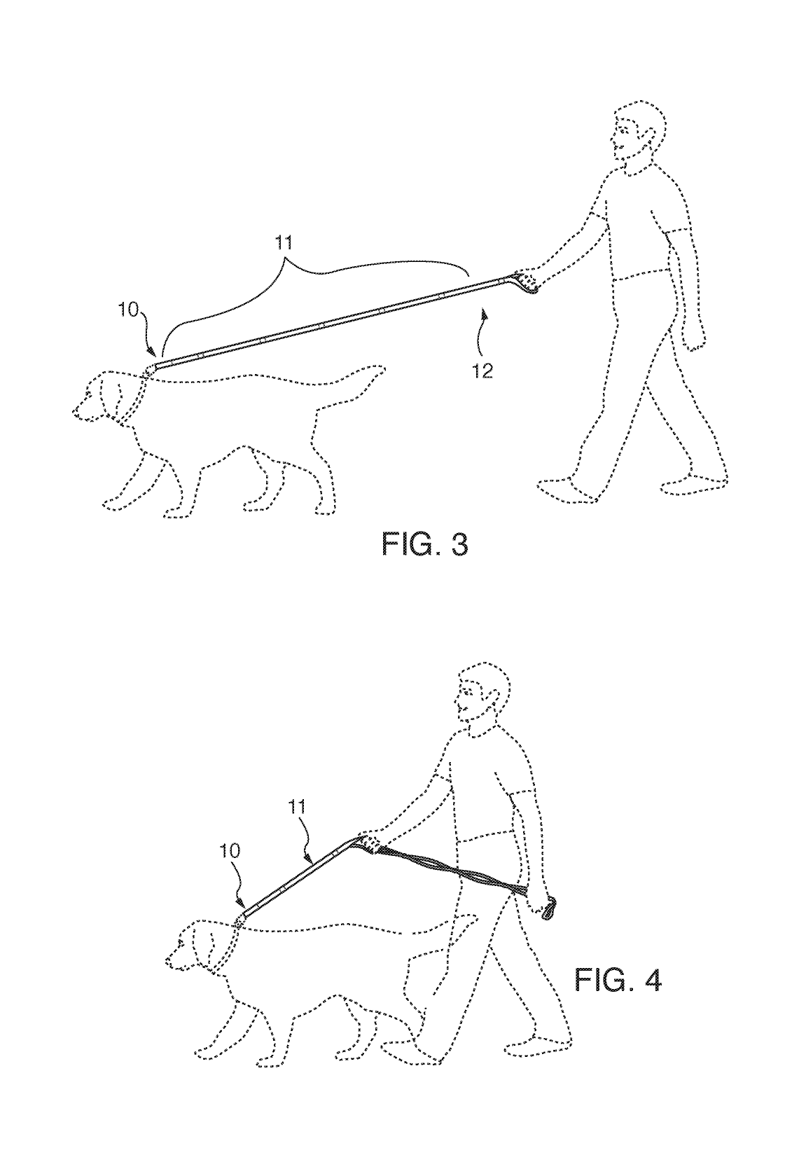

FIG. 3 depicts a preferred embodiment of a method of operation of the present invention. Specifically, the leash is under tension, so the control loops (11) are collapsed onto one another removing any snagging risk. The hander of the canine's hand is “hooked” at the handle end of the leash (12) for control of the canine. This open hand “hooked” technique permitted by the stitched loops of the present invention reduces hand fatigue.

FIG. 4 depicts a further preferred embodiment of a method of operation of the present invention. Here, the handler has adjusted the distance from the canine by simply grasping for the connection point of a control loop (11) closer to the canine's collar connection (10). In this way, with the stitched connection points between the control loops (11) on the leash of the present invention, the handler has complete flexibility to adjust the lead distance to the canine with simple hand manipulation in seconds. This functionality is critical in adjusting the handling of the canine “on the spot” without delay as circumstances warrant. Further, the loops allow for a positive control point in the event of a wet leash or if the handler's hands or gloves are wet.

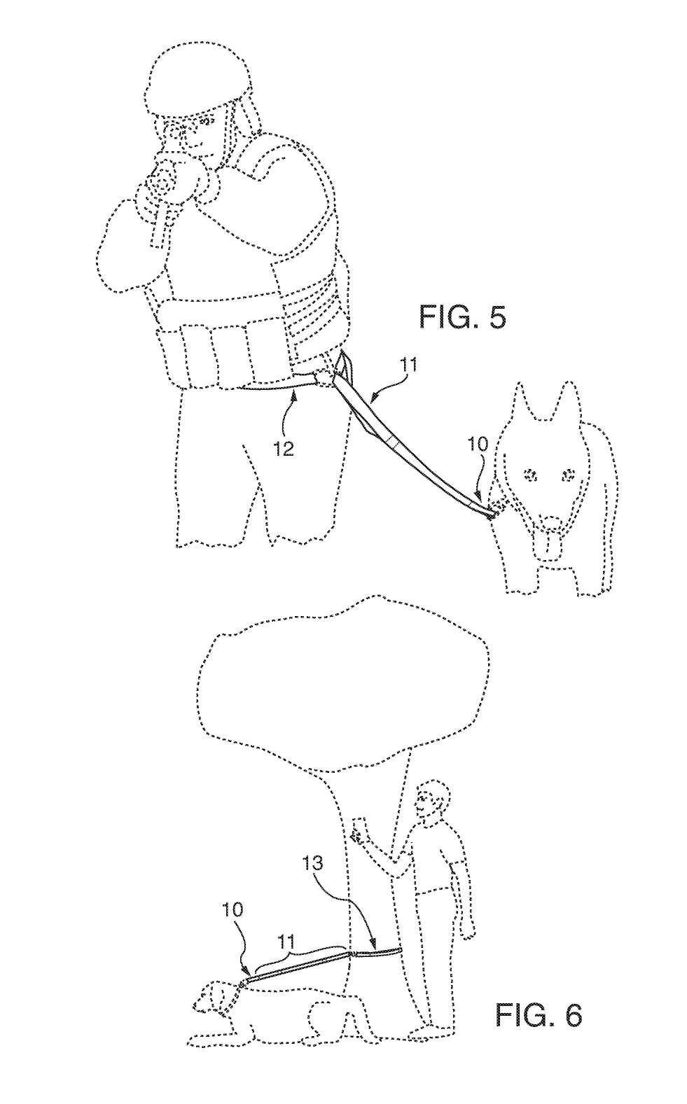

FIG. 5 depicts a hands free and snag free operation of the canine. Here, a military or law enforcement handler has looped the leash around his or her waist and looped the canine collar attaching end (10) through one of the control loops (11) to secure the leash around the handler's waist and attached a canine to the canine collar attaching end (10). In a preferred embodiment, the canine would be attached to the leash by redundant carabineers (FIG. 2A) and the leash distance from the handler would be short. In this way, the canine will be able to operate directly in front or to the side of the handler while the handler scans the area ahead for threats and is free to operate a weapon with both hands. See, FIG. 5. Further, the collapsible control loop (11) feature prevents any snagging hazard since the leash portion from the handler's waist to the canine's collar is under tension and therefore taught.

In another preferred embodiment of the method depicted in FIG. 5, the leash is secured around the handler's waist by carabineers inserted into the attachment point created by the two parallel bar tack stitched connection points between the loops offering a small loop for use of a control device (i.e., a carabineer) for additional functionality and adaptability. See, FIG. 2A.

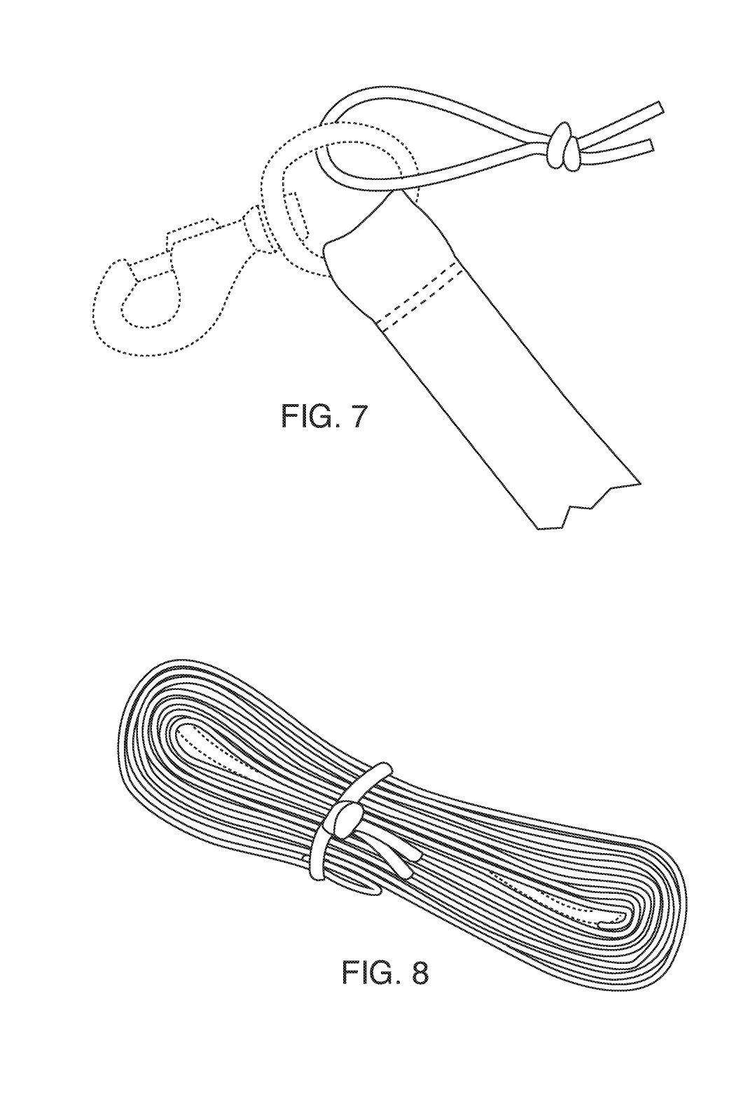

FIG. 6 depicts the leash used to secure a canine to a stationary object or hard point. Here, the handler has looped the leash around a tree (13) and looped the canine collar attaching end through one of the control loops (11) to secure the leash around the tree and attached a canine to the canine collar attaching end (10). In another preferred embodiment of the method depicted in FIG. 6, the leash is secured around the tree by carabineers inserted into the attachment point created by the two parallel bar tack stitched connection points between the loops offering a small loop for use of a control device (i.e., a carabineer) for additional functionality and adaptability. See, FIG. 2A.

FIG. 7 depicts an alternative preferred embodiment of a hock and clasp connector to the canine collar attachments end of the leash exhibiting an elastic cord secured to the hook and clasp connector. The elastic string is used to secure the leash when it is rolled up (FIG. 8) for storage. Of course, this same elastic cord can be secured to carabineer connectors or any other canine collar attachment device used.

Without departing from the spirit or intent of the present invention, the leash of the present invention can have one loop control point or a plurality of loop control points. Of course, the control loops themselves can vary in size. Additionally, the leash of the present invention can be of any length depending upon the handler, task and control needs. The embodiments presented here are preferred embodiments but not limitations of the invention.

Those of ordinary skill in the art will recognize that the embodiments just described merely illustrate the principals of the present invention. Many obvious modifications may be made thereto without departing from the spirit or scope of the invention as set forth in the appended claims.

1. A loop leash canine control device comprising the following:
an elongate segment of flexible material with two ends;
a handle loop on one end and canine collar attaching loops at the other end of the elongate segment of flexible material;
a plurality of loops located between the handle loop and canine collar attaching loops of the segment of flexible material for additional handling functionality.

2. The loop leash canine control device of claim 1, where the handle loop, the canine attaching loops and the plurality of loops located between the handle loop and the canine attaching loops are flush and collapse when the elongate segment of flexible materials is under a tension force.

3. The loop leash canine control device of claim 1, where the elongate segment of flexible material is made from nylon.

4. The loop leash canine control device of claim 2, where the elongate segment of flexible material is made from nylon.

5. The loop leash canine control device of claim 1, where all of the loops on the elongate segment of flexible material are stitched.

6. The loop leash canine control device of claim 2, where all of the loops on the elongate segment of flexible material are stitched.

7. The loop leash canine control device of claim 5, where an additional stitching line is provided parallel to the stitching forming the plurality of loops located between the handle loop and canine collar attaching loops of the segment of flexible material for a canine collar attachment point at each of the plurality of loops.

8. The loop leash canine control device of claim 6, where an additional stitching line is provided parallel to the stitching forming the plurality of loops located between the handle loop and canine collar attaching loops of the segment of flexible material for a canine collar attachment point at each of the plurality of loops.

9. The loop leash canine control device of claim 5, where the elongate segment of flexible material is not greater than 7 feet long and each of the a plurality of loops located between the handle loop and canine collar attaching loops of the segment of flexible material are located at intervals of no greater than 1 foot along the segment of flexible material.

10. The loop leash canine control device of claim 6, where the elongate segment of flexible material is not greater than 7 feet long and each of the a plurality of loops located between the handle loop and canine collar attaching loops of the segment of flexible material are located at intervals of no greater than 1 foot along the segment of flexible material.

11. The loop leash canine control device of claim 7, where the canine collar attaching loops of the segment of flexible material are attached to the canine collar by means of carabineers.

12. The loop leash canine control device of claim 8, where the canine collar attaching loops of the segment of flexible material are attached to the canine collar by means of carabineers.

13. The loop leash canine control device of claim 7, where the canine collar attaching loops of the segment of flexible material are attached to the canine collar by means of a loop and clasp attachment device.

14. The loop leash canine control device of claim 8, where the canine collar attaching loops of the segment of flexible material are attached to the canine collar by means of a loop and clasp attachment device.

15. The loop leash canine control device of claim 7, where an elastic cord is attached to the canine collar attaching loops collar attaching device for use in storing the loop leash canine control device.

16. The loop leash canine control device of claim 8, where an elastic cord is attached to the canine collar attaching loops collar attaching device for use in storing the loop leash canine control device.

17. A method of handling a canine, comprising:
providing an elongate segment of flexible material with two ends; a handle loop on one end and Canine collar attaching loops at the other end of the elongate segment of flexible material; a plurality of loops located between the handle loop and Canine collar attaching loops; where the handle loop, the canine attaching loops and the plurality of loops located between the handle loop and the canine attaching loops are flush and collapse when the elongate segment of flexible materials is under a tension force:
looping the elongate segment of flexible material with two ends around a user's waist;
securing the elongate segment of flexible material with two ends around the user's waist by means of one of the plurality of loops located between the handle loop and the canine collar attaching loops;
securing the canine onto the elongate segment of flexible material with two ends secured around the user's waist by means of the canine collar attaching loops;
operating the canine in unison with the user in a hands free configuration.

18. A method of handling a canine, comprising:
providing an elongate segment of flexible material with two ends; a handle loop on one end and Canine collar attaching loops at the other end of the elongate segment of flexible material; a plurality of loops located between the handle loop and Canine collar attaching loops; where the handle loop, the canine attaching loops and the plurality of loops located between the handle loop and the canine attaching loops are flush and collapse when the elongate segment of flexible materials is under a tension force:
securing the canine onto the elongate segment of flexible material with two ends secured around the user's waist by means of the canine collar attaching loops;
adjusting the distance of the canine from the handler by manual manipulation of the plurality of loops located between the handle loop and the canine collar attaching loops.

19. A method for folding and storing a loop leash canine control device, comprising:
providing an elongate segment of flexible material with two ends; a handle loop on one end and Canine collar attaching loops at the other end of the elongate segment of flexible material; a plurality of loops located between the handle loop and canine collar attaching loops; where the handle loop, the canine attaching loops and the plurality of loops located between the handle loop and the canine attaching loops are flush and collapse when the elongate segment of flexible materials is under a tension force and an elastic cord is attached to the canine collar attaching loops collar attaching device for use in storing the loop leash canine control device.
folding the loop leash canine control device onto itself;
wrapping the elastic cord around the folded loop leash canine control device.
